(19) United States
(12) Patent Application Publication
(10) Pub. No.: US 2005/0171682 A1
(43) Pub. Date: Aug. 4, 2005

(54) Fcd system and device using beacon

(75) Inventor: Shinya Adachi, Kanagawa (JP)

Correspondence Address: PEARNE & GORDON LLP, 1801 EAST 9TH STREET, SUITE 1200, CLEVELAND, OH, 44114-3108, US

(73) Assignee: Matsushita Electric Industrial Co., Ltd, kadoma-shi, Osaka (JP)

(21) Appl. No.: 10/517,791

(22) PCT Filed: Jun. 9, 2003
(86) PCT No.: PCT/JP03/07284

(30) Foreign Application Priority Data
Jun. 14, 2002 (JP) 2002-174424

(51) Int. Cl. G08G 1/00

(52) U.S. Cl. 701/117; 701/205

(57) ABSTRACT

An object of the present invention is to provide an FCD system capable of collecting effectively traveling locus data of a vehicle while putting characteristics of beacons into practical use and then analyzing detailed traffic conditions.

In a system of the present invention for collecting traveling locus data from a in-vehicle unit in a vehicle via beacons, a downstream-side beacon (20) collects the traveling locus data, then calculates a traveling distance of the vehicle from an upstream-side beacon (10) to the downstream-side beacon (20) based on the traveling locus data, and then decides whether or not the traveling locus data of the vehicle are used in analyzing traffic conditions of the objective road, by comparing the traveling distance with a distance on an objective road from the upstream-side beacon (10) to the downstream-side beacon (20). The high-precision traffic information can be obtained by collecting the traveling locus data of the vehicle effectively by using the beacons.

### TECHNICAL FIELD

The present invention relates to a floating car data (FCD) system for collecting data indicating traveling conditions from vehicles to use them as traffic information and facilities constituting the same and, more particularly, a system for making a data collection by using beacons.

### BACKGROUND ART

In recent years, an introduction of the system that is called the probe car (or the floating car) using the vehicle as a sensor to collect the traffic information is investigated. In this system, the FCD in-vehicle unit installed into the vehicle records data such as a traveling speed, a position, etc. of the vehicle and then transmits the data to the center equipment, while the center equipment analyzes traveling locus data transmitted from respective vehicles and generates road traffic information about the traffic flow, etc.

Currently the system of transmitting the data being recorded by the FCD in-vehicle unit to the center equipment at a predetermined interval via the cellular phone is investigated in this system.

Meanwhile, the beacons are arranged over the road to provide VICS road traffic information to the passing vehicle with pinpoint. There are two types of the beacon, the light beacon and the radio beacon. The light beacon out can perform the two-way communication between the in-vehicle unit and the beacon (data transfer rate 1 Mbps).

At present, the information collection described in the following are executed by utilizing the two-way communication of the light beacon. In this case, the distance between the beacons is set variously according to the arranging condition, etc. but is about several hundreds m to several km.

As shown in FIG. 17, following processes are applied.

(1) When the vehicle passes under an upstream-side beacon 10, this beacon 10 transmits “the beacon number” of the beacon 10 to the in-vehicle unit. This in-vehicle unit accumulates this beacon number,

(2) When the vehicle passes under a downstream-side beacon 20, the in-vehicle unit transmits “the last passed beacon number” and “a time elapsed from the time when the vehicle passed the last beacon” to the beacon 20. The beacon 20 transmits “the beacon number” of the beacon 20 to the in-vehicle unit, and the in-vehicle unit accumulates this beacon number.

(3) The center equipment measures the time required between the beacon 10 and the beacon 20 based on information that the downstream-side beacon 20 received.

In this manner, it is possible to collect a travel time between the beacons by using the light beacons.

However, the collection of the travel time by using the light beacons contains the problems described in the following.

(1) As shown in FIG. 18, it is impossible to discriminate whether the vehicle that informed the beacon 20 of the travel time information passed through the road A as a target of the traffic information collection or passed through the road B.

(2) It is only the time required between the beacons that the center equipment can measure. The center equipment cannot catch the density condition of the traffic congestion between the beacons.

(3) It is difficult to discriminate whether or not the vehicle that informed the beacon 20 of the travel time information had stopped in the middle.

In the existing state, abnormal values in the collected travel time data (data of the vehicle passed through the road B in (1) or the stopped vehicle in (3)) are decided by using the statistical approach, and then the travel times on the target road A except these abnormal values are analyzed. However, a lot of data must be collected to apply this approach and the traffic conditions changes moment by moment during this collection. As a result, it is difficult to catch the traffic conditions quickly in detail by the approaches in the conventional manner.

On the other hand, the FCD system using the cellular phone involves such a big problem that the user must bear the communication rate.

The present invention has been made to overcome such problems in the conventional art, and it is an object of the present invention to provide an FCD system capable of collecting traveling locus data of vehicles effectively by making the best use of beacons to analyze detailed traffic conditions and facilities constituting the system.

### DISCLOSURE OF THE INVENTION

Therefore, in a system of the present invention for collecting traveling locus data from a in-vehicle unit in a vehicle via beacons, a downstream-side beacon collects the traveling locus data, then calculates a traveling distance of the vehicle from an upstream-side beacon to the downstream-side beacon based on the traveling locus data, and then decides whether or not the traveling locus data of the vehicle are used in analyzing traffic conditions of the objective road, by comparing the traveling distance with a distance on an objective road from the upstream-side beacon to the downstream-side beacon.

The downstream-side beacon collects the traveling locus data, then specifies transit road intervals of the vehicle, which come up to the beacon, by using position data contained in the traveling locus data, and then specifies speed data by interpolating points between speed data measuring points in the transit road intervals by using speed data contained in the traveling locus data.

In an FCD collecting facility for collecting traveling locus data from a in-vehicle unit in a vehicle via beacons, the traveling locus data are collected by a downstream-side beacon, then a traveling distance of the vehicle from an upstream-side beacon to the downstream-side beacon is calculated based on the traveling locus data, and then it is decided whether or not the traveling locus data of the vehicle are used in analyzing traffic conditions of the objective road, by comparing the traveling distance with a distance on an objective road from the upstream-side beacon to the downstream-side beacon.

The traveling locus data are collected by a downstream-side beacon, then transit road intervals of the vehicle, which come up to the downstream-side beacon from an upstream-side beacon, are specified by using position data contained in the traveling locus data, and then speed data are specified by interpolating points between speed data measuring points in the transit road intervals by using speed data contained in the traveling locus data.

In a in-vehicle unit for transmitting traveling locus data of a vehicle equipped with the unit to beacons, the traveling locus data measured after the vehicle passed under an upstream-side beacon are coded, and transmitted to a downstream-side beacon.

According to such configuration, the high-precision traffic information can be obtained by collecting the traveling locus data of the vehicle effectively by using the beacons.

### BRIEF DESCRIPTION OF THE DRAWINGS

FIG. 1 is a view showing a data transmission mode in an FCD system in a first embodiment of the present invention.

FIG. 2 is a view showing data formats of transmission data in the first embodiment of the present invention.

FIG. 3 is a view showing a data transmission mode in an FCD system in a second embodiment of the present invention.

FIG. 4 is a view showing data formats of transmission data in a third embodiment of the present invention.

FIG. 5 is a view showing a configuration of an FCD system in the third embodiment of the present invention.

FIG. 6 is a view showing a data transmission mode in an FCD system in a fourth embodiment of the present invention.

FIG. 7 is a view showing a data format of coding instruction data in the fourth embodiment of the present invention.

FIG. 8 is a view showing a quantization table used in the fourth embodiment of the present invention.

FIG. 9 is a view showing code tables used in the fourth embodiment of the present invention.

FIG. 10 is a view showing a data format of traveling locus data in the fourth embodiment of the present invention.

FIG. 11 is a block diagram showing a configuration of the FCD system in the fourth embodiment of the present invention.

FIG. 12 is a flowchart showing procedures of forming the coding instruction data in the fourth embodiment of the present invention.

FIG. 13 is a flowchart showing operational procedures of the FCD system in the fourth embodiment of the present invention.

FIG. 14 is a view showing a first configuration of an FCD system in a fifth embodiment of the present invention.

FIG. 15 is a view showing a second configuration of the FCD system in the fifth embodiment of the present invention.

FIG. 16 is a flowchart showing operational procedures of the FCD system in the fifth embodiment of the present invention.

FIG. 17 is an explanatory view showing information collection by using the beacons in the prior art.

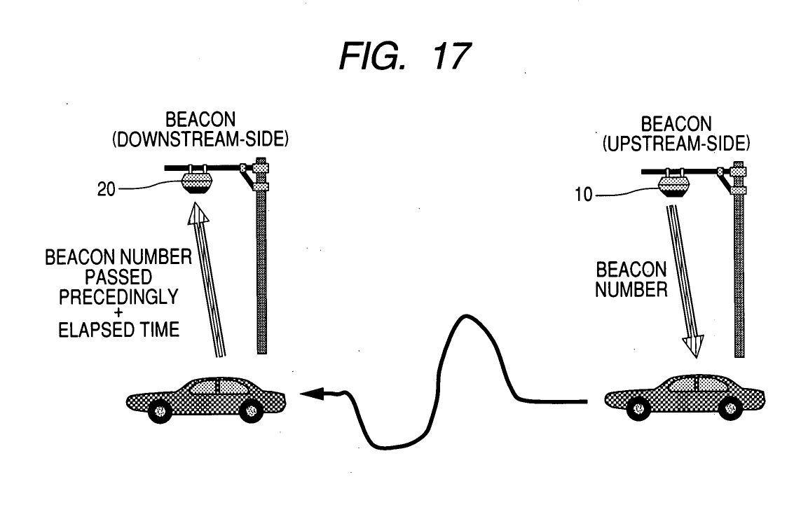

FIG. 18 is an explanatory view showing the problem in the information collection by using the beacons in the prior art.

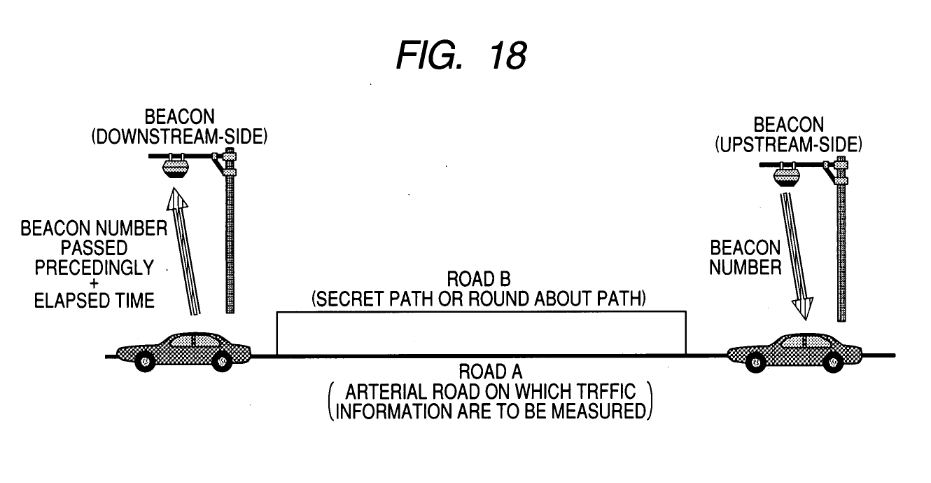

In above Figures, respective reference numerals are given as follows.
10 upstream-side beacon
11 traffic condition deciding portion
12 coding instruction forming portion
13 coding instruction selecting portion
14 traffic sensor
20 downstream-side beacon
21 traveling locus receiving portion
22 beacon arranging position data
23 beacon information adding portion
24 coding data decoding portion
25 traveling locus information utilizing portion
26 traveling route/stop deciding portion
50 FCD in-vehicle unit
51 data receiving portion
52 coding instruction data
53 default coding instruction data
54 traveling locus accumulating portion
55 user's own vehicle position deciding portion
56 coding processing portion
57 traveling locus transmitting portion
58 GPS antenna
59 gyro
60 speed sensor
61 coding instruction selecting portion
62 coding information selecting portion
111 sensor processing portion
112 traffic condition deciding portion
121 code table calculating portion
122 coding instruction data
123 traveling locus data
131 coding instruction selecting portion
132 coding instruction transmitting portion

133 beacon number/coding instruction transmitting portion
134 beacon number management data
521 coding instruction data
522 coding instruction data
561 coding processing portion
562 coding processing portion

### BEST MODE FOR CARRYING OUT THE INVENTION

### First Embodiment

In a first embodiment, a system in which the in-vehicle unit measures an “average speed” or a “transit time” every unit interval in unit of a predetermined distance and then uploads measured data to the downstream-side beacon will be explained hereunder.

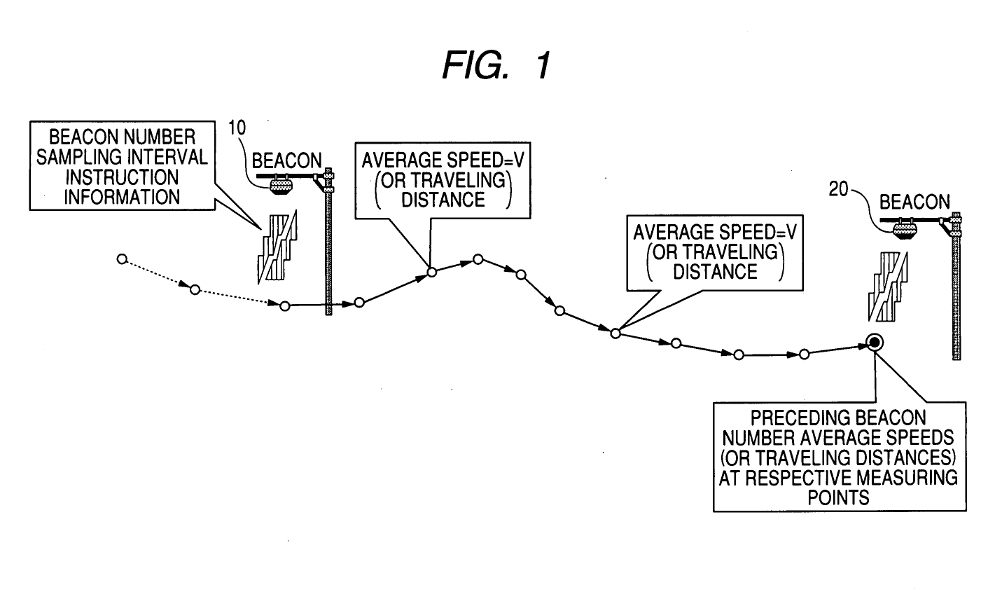

In this system, as shown in FIG. 1, the upstream-side beacon 10 and the downstream-side beacon 20 are provided at an objective road section over which the traffic information are to be collected, and the distance between the beacons in the objective road section has already been known.

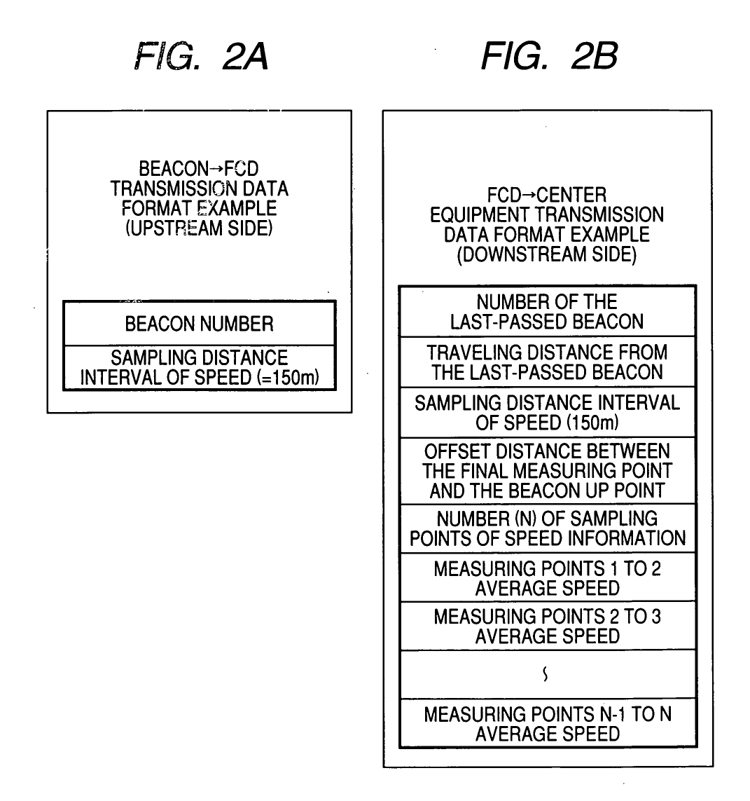

The upstream-side beacon 10 uploads its own beacon number and a sampling interval in data measurement to the FCD-equipped unit in the passing vehicle. Here, as shown in FIG. 2(a), the upstream-side beacon 10 instructs a distance (e.g., 150 m) of the unit interval, in which an average speed is to be measured, as the sampling interval. In FIG. 1, a distance between white dots is represented as a unit interval.

The in-vehicle unit records the average speed in the unit interval every time when the vehicle travels through the instructed distance (150 m), and then uploads traveling locus data including the information of the recorded average speed in the unit interval and the beacon number of the last-passed upstream-side beacon 10 to the downstream-side beacon 20 when the vehicles comes up to the position of the downstream-side beacon 20.

As shown in FIG. 2(b), “the number of the last-passed beacon”, “the sampling distance interval of speed”, “an offset distance between the final measuring point and the beacon up point (a distance (a fraction component below 150 m) between the final point for measuring speed (150 m pitch) and the upload point to the downstream-side beacon 20)”, “the number of sampling points of the speed information”, and “the average speed in each unit interval” are contained in the traveling locus data that are sent from the FCD in-vehicle unit to the downstream-side beacon 20. When a margin is still left in the transmission path capacity, “the traveling distance from the last-passed beacon” maybe contained in the traveling locus data. However, although such traveling distance is not contained, the downstream-side beacon 20 can calculates “the traveling distance from the last-passed beacon” based on “the sampling distance interval of speed”, “the number of sampling points of the speed information”, and “the offset distance between the final measuring point and the beacon up point”.

Since the distance between the beacons on the objective road section has already been known, the downstream-side beacon 20 or the center equipment connected thereto compares this distance with “the traveling distance from the last-passed beacon” detected from the traveling locus data to decide whether the vehicle with the in-vehicle unit passed through the objective road section or passed through the roundabout route. The traveling locus data being collected from the vehicle that passed through the roundabout route are excluded from materials used to decide the traffic conditions in the objective road section.

The average speeds in respective unit intervals in the traveling locus data of individual vehicles are compared mutually, and it is decided that the vehicle is stopped in the interval in which the average speed is extremely slow rather than other intervals. In this case, data of the stopped interval and its neighboring intervals (=intervals needed to accelerate/decelerate the vehicle) are excluded from the materials used to decide the traffic conditions in the objective road section.

Then, remaining traveling locus data obtained by excluding these data from the collected data are analyzed statistically, and a density of the traffic jam in the objective road section is analyzed based on the average speeds in respective unit intervals.

In this manner, this system can decide exactly the vehicle that passed through the roundabout route or the vehicle that was stopped, and then analyze exactly the traffic conditions in the objective road in detail by excluding these data.

In this case, in place of measuring the average speed in the unit interval, the in-vehicle unit may measure “a transit time” needed to pass through the unit interval. This is because the average speed in the unit interval can be calculated by using “the transit time” and “the sampling distance interval of speed” on the side of the downstream-side beacon 20 or the center equipment connected thereto.

In place of the average speed in the unit interval, the speed may be measured every time when the vehicle runs through each unit interval and this speed may be contained in the traveling locus data.

150 m is exemplified herein as “the sampling distance interval of speed”, but such interval may be set to about 50 to 300 m. In the case where the sampling distance interval should be set short in the urban district where the distance between the beacons is set short but should be set long in the mountainous district or the like where the distance between the beacons is set long, the traveling locus data used to know the traffic conditions in the objective road section can be collected effectively. Thus, if the instruction information of the sampling interval is transmitted from the beacon to the in-vehicle unit, the unit interval can be set in response to the beacon providing condition. The in-vehicle unit may decide the sampling interval for itself by discriminating the traveling district. In this case, only the beacon number is contained in the downloaded data in FIG. 2(a).

### Second Embodiment

In the second embodiment, a system in which the in-vehicle unit measures “the average speed” or “the traveling distance” every unit time in unit of a predetermined time and then uploads the measured data to the downstream-side beacon will be explained hereunder.

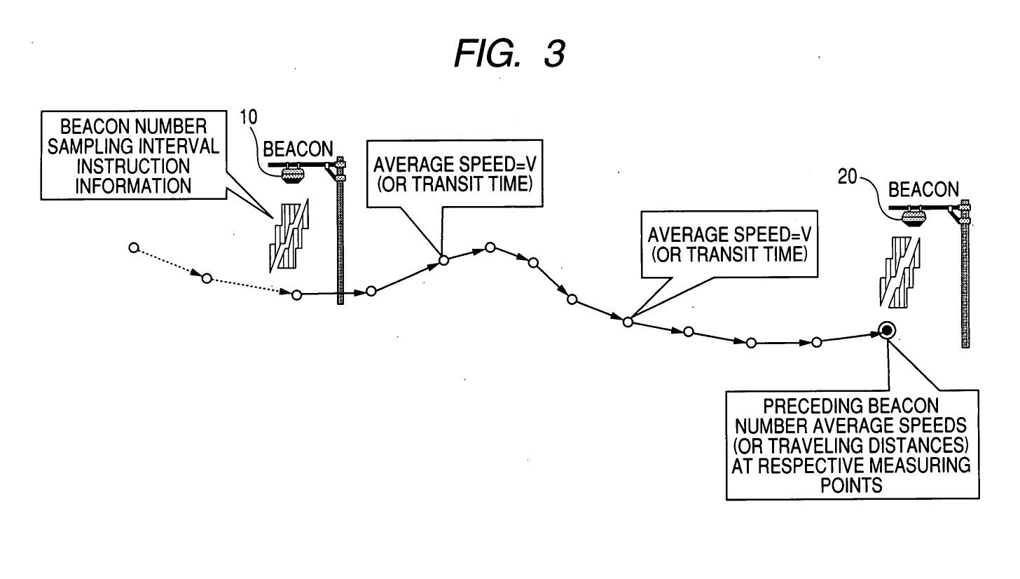

In this system, as shown in FIG. 3, the upstream-side beacon 10 downloads its own beacon number and the unit time (about 2 to 30 second) as the sampling interval to the FCD in-vehicle unit in the vehicle that is passing under there.

The in-vehicle unit records the average speed every time when the instructed unit time has lapsed, and uploads the traveling locus data including “the number of the last-passed beacon”, “the sampling time interval of speed”, “the offset distance between the final measuring point and the beacon up point”, “the number of sampling points of the speed information”, and “the average speed in each unit time” to the downstream-side beacon 20 when the vehicle arrives at the position of the downstream-side beacon 20.

In this case, if there is a margin in the transmission path capacity, “the traveling distance from the last-passed beacon” may be contained in the traveling locus data. However, unless such traveling distance is contained, the downstream-side beacon 20 can calculate “the traveling distance from the last-passed beacon” by adding “the offset distance between the final measuring point and the beacon up point” to an accumulated value of (“the sampling time interval of speed”×“the average speed in each unit time”).

Like the first embodiment, the downstream-side beacon 20 or the center equipment connected thereto compares the distance between the beacons in the objective road section with “the traveling distance from the last-passed beacon” detected from the traveling locus data to decide the vehicle that passed through the roundabout route. The traveling locus data being collected from the concerned vehicle are excluded from materials used to decide the traffic conditions in the objective road section.

The average speeds in respective unit intervals in the traveling locus data of individual vehicles are compared mutually, and it is decided that the vehicle is stopped in the interval in which the average speed is extremely slow rather than other intervals. Such data are excluded from the materials used to decide the traffic conditions in the objective road section.

Then, remaining traveling locus data obtained by excluding these data from the collected data are analyzed statistically, and the density of the traffic congestion in the objective road section is analyzed based on the average speeds in respective unit intervals.

In this case, instead of measuring the average speeds in respective unit intervals, “the traveling distance” (=unit time×average speed) in the unit time may be measured.

Like the first embodiment, “the sampling time interval of speed” may be varied.

### Third Embodiment

In a third embodiment, a method of reducing an amount of data of the average speed, the transit time, or the traveling distance will be explained hereunder. The speed information is taken as an example herein.

A reduction in an amount of data is executed by converting the speed information into data having a bias statistically and then converting the converted data into the variable-length code by using a code table. This approach was described in detail in Patent Application No. 2001-329242, etc., which was proposed in advance by the inventors of the present invention.

In order to convert the information into the data having a bias statistically, for example, the measured value is represented as a difference from the preceding measured value. When doing this, difference speed data gather around 0 when the vehicle passed through the objective road section at an almost uniform speed.

Meanwhile, in the code table, a value having a small bit number is assigned to the difference speed data located near ±0, a frequency of occurrence of which is high, and a value having a large bit number is assigned to the difference speed data, a frequency of occurrence of which is low. Then, the difference speed data are converted into the variable-length codes by using this code table, so that an amount of data can be reduced. If the run length compression is carried out at that time by applying the run length coding to continuous same values contained therein, an amount of data can be further reduced.

If the speed data are quantized before such speed data are represented by using the difference and then the quantized value are represented by using the difference, an amount of data can be largely reduced. Because the center equipment must grasp the congested traffic conditions in detail in quantization of the speed data, the slow speed is finely quantized and then the speed data are quantized roughly as the speed is built up gradually.

In the case where the speed data are quantized in the following manner, for example,
0 to 1 km/h→1
2 to 3 km/h→2
4 to 8 km/h→3
9 to 18 km/h→4
19 to 29 km/h→5
30 to 39 km/h→6
40 to 49 km/h→7
   the difference between the quantized values becomes 0 even when the speed data is changed from 33 km/h to 38 km/h at the next measuring point. Thus, a compression effect achieved by the variable-length coding can be enhanced.

The upstream-side beacon or the center equipment connected thereto (i.e. FCD collecting facility) downloads the coding system, the quantization unit of the speed information, and the code table to the in-vehicle unit, while the in-vehicle unit uploads measured speed data, which are coded by the designated coding system, to the downstream-side beacon.

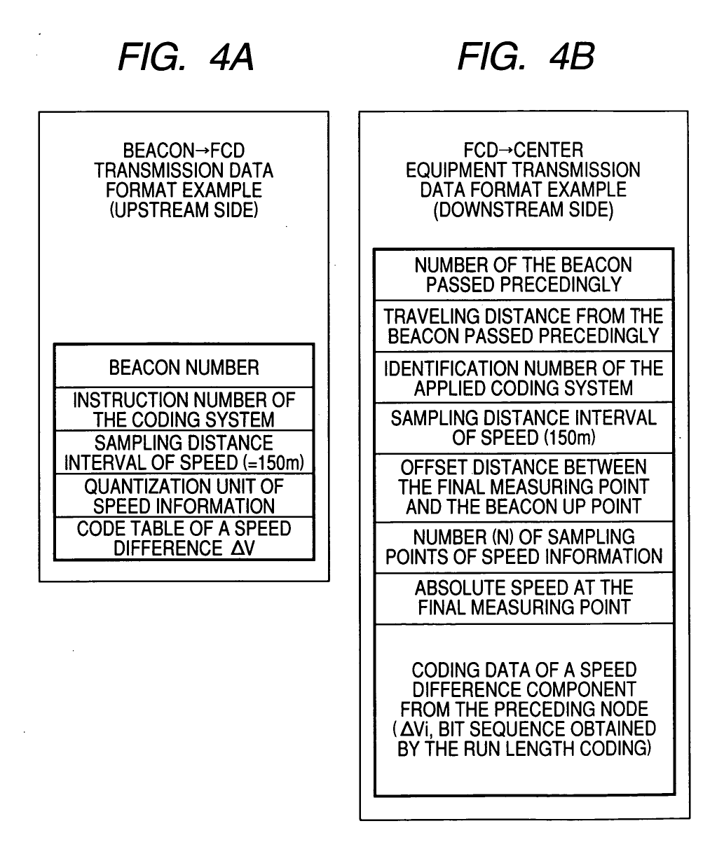

FIG. 4(a) shows the data that are downloaded from the upstream-side beacon 10 in this case, and FIG. 4(b) shows a data structure of the data that the in-vehicle unit uploads to the downstream-side beacon 20. Coding instruction data pointing the sampling interval, the quantization unit, and the code table are contained in FIG. 4(a), and coded data of the speed difference and an absolute speed at the final measuring point required to convert the speed difference into the speed data are contained in FIG. 4(b).

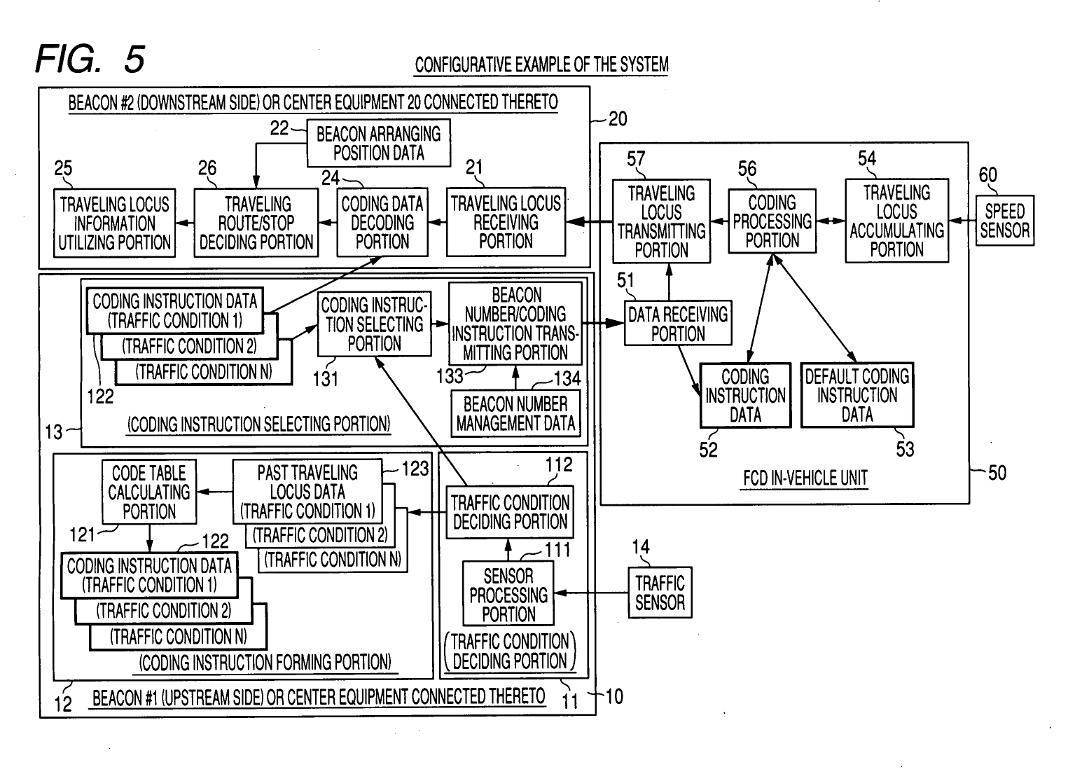

FIG. 5 shows a configuration of this system including the upstream-side beacon (or the center equipment connected thereto) 10, the downstream-side beacon (or the center equipment connected thereto) 20, and an FCD in-vehicle unit 50 in a block diagram.

The upstream-side beacon (or the center equipment connected thereto) 10 includes a traffic condition deciding portion 11 for deciding the traffic conditions, a coding instruction forming portion 12 for forming the coding instruction data (sampling interval, quantization unit, and code table) from the past traveling locus data in response to various traffic conditions, and a coding instruction selecting portion 13 for downloading the selected coding instruction data to the FCD in-vehicle unit 50 in the passing vehicle.

The traffic condition deciding portion 11 has a sensor processing portion 111 for processing sensor information from a traffic sensor 14 including the FCD, and a traffic condition deciding portion 112 for deciding the traffic conditions based on the information from the traffic sensor.

The coding instruction forming portion 12 includes a code table calculating portion 121 for calculating coding instruction data (sampling interval, quantization unit, and code table) 122 that permit the effective coding of the speed data in the traffic conditions in respective patterns by using past traveling locus data 123 that are classified into traffic condition patterns.

The coding instruction selecting portion 13 includes a coding instruction selecting portion 131 for selecting the coding instruction data 122 in response to the traffic conditions that is decided by the traffic condition deciding portion 112, and a beacon number/coding instruction transmitting portion 133 for downloading the beacon number managed in beacon number management data 134 and the selected coding instruction data to the FCD in-vehicle unit 50.

The FCD in-vehicle unit 50 has a data receiving portion 51 for receiving coding instruction data 52 from the upstream-side beacon 10, a default coding instruction data 53 held in advance by the FCD in-vehicle unit 50, a traveling locus accumulating portion 54 for accumulating sensed data of a speed sensor 60, a coding processing portion 56 for coding measured data accumulated in the traveling locus accumulating portion 54 by using the coding instruction data 52 or 53, and a traveling locus transmitting portion 57 for transmitting the traveling locus data to the downstream-side beacon 20.

The downstream-side beacon (or the center equipment connected thereto) 20 includes a traveling locus receiving portion 21 for receiving the traveling locus data from the FCD in-vehicle unit 50, a beacon arranging position data 22 for indicating arranged positions of the upstream-side beacon 10 and the downstream-side beacon 20, a coding data decoding portion 24 for decoding the coded traveling locus data, a traveling route/stop deciding portion 26 for excluding the traveling locus data of the vehicle that passed through the routes other than the objective road section and the stopped vehicle, and a traveling locus information utilizing portion 25 for utilizing the traveling locus data in the analysis of the traffic flow, and forth.

In this case, functions of respective portions of the upstream-side beacon 10, the downstream-side beacon 20, and the FCD in-vehicle unit 50 can be realized by causing the computers built in these devices to execute the processes specified by the program.

In this system, the traffic condition deciding portion 11 in the upstream-side beacon 10 decides the traffic conditions based on the sensor information of the traffic sensor 14, and then transfers the traffic conditions to the coding instruction forming portion 12 and the coding instruction selecting portion 13.

The coding instruction forming portion 12 classifies the past traveling locus data 123 into patterns in response to the traffic conditions transferred at that time from the traffic condition deciding portion 11, and then forms the coding instruction data (sampling interval, quantization unit, and code table) 122 used to encode the speed data in the traffic conditions in respective patterns by using the traveling locus data 123.

The coding instruction selecting portion 13 selects the coding instruction data 122, which are in conformity with the current traffic conditions decided by the traffic condition deciding portion 112, from the coding instruction data 122 formed previously by the coding instruction forming portion 12, and then downloads such data together with the beacon number to the FCD in-vehicle unit 50 in the passing vehicle. The selected coding instruction data 122 are transmitted to the downstream-side beacon 20.

The FCD in-vehicle unit 50 saves these data when the unit receives the beacon number and the coding instruction data 52 from the upstream-side beacon 10, and then collects the speed data of the traveling vehicle sensed by the speed sensor 60 and accumulates such data in the traveling locus accumulating portion 54. Then, the FCD in-vehicle unit 50 encodes the speed data accumulated in the traveling locus accumulating portion 54 by using the coding instruction data 52, and then uploads the coded data to the downstream-side beacon 20 when such unit passes under the downstream-side beacon 20. In this case, when the FCD in-vehicle unit did not receive the coding instruction data from the upstream-side beacon 10, such unit executes this coding operation by using the default coding instruction data 53.

The downstream-side beacon 20, when receives the traveling locus data, decodes the coded traveling locus data by using the code table informed by the upstream-side beacon 10, and then decides whether the vehicle equipped with this FCD in-vehicle unit 50 passed through the objective road section or passed through the roundabout route by comparing “the traveling distance after the vehicle passed under the upstream-side beacon 10” derived from the traveling locus data with the distance between the beacons managed by the beacon arranging position data 22. The traveling locus data being collected from the vehicle that passed through the roundabout route are excluded from materials used to decide the traffic conditions in the objective road section.

The interval in which the vehicle is stopped is discriminated by comparing the speed data in each unit interval in the traveling locus data, and then the data in that interval are excluded from the materials used to decide the traffic conditions in the objective road section. The traffic conditions in the objective road section is analyzed by using remaining data and utilized as the traffic information.

In this fashion, an amount of data that is uploaded from the FCD in-vehicle unit 50 to the downstream-side beacon 20 can be reduced by coding the traveling locus data. Thus, the traveling locus data can be transmitted without trouble in a short time in which the vehicle passed under the downstream-side beacon 20.

### Fourth Embodiment

In a fourth embodiment, a system in which the FCD in-vehicle unit measures the speed data as well as the position data and uploads these data to the downstream-side beacon, and then the downstream-side beacon identifies the road through which the vehicle passed based on the position data will be explained hereunder. In this embodiment, the traffic conditions can be collected by identifying not only the road between upstream-side and downstream-side beacons but also the road that comes up to the beacon by virtue of one beacon.

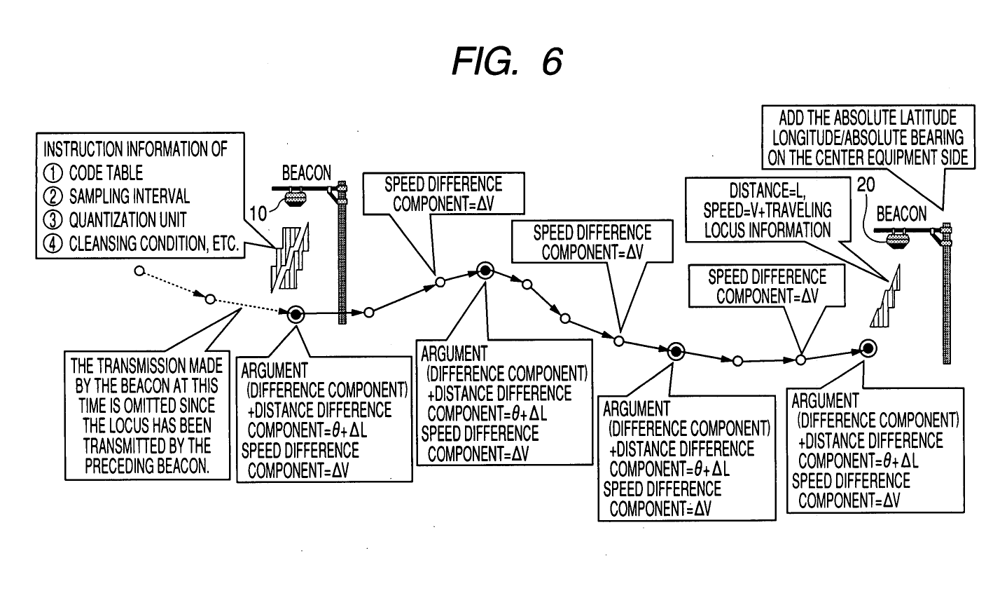

In this FCD system, as shown in FIG. 6, the FCD in-vehicle unit measures the position information at the point indicated by a double circle and measures the speed information at the points indicated by a double circle and a white dot more densely than the position information. The FCD in-vehicle unit uploads these measured data to the downstream-side beacon 20 when the vehicle passed under the downstream-side beacon 20.

The downstream-side beacon 20 (or the center equipment connected thereto) executes a map matching by using the intermittent position information contained in the received traveling locus data, and identifies the road through which the vehicle passed. Then, the measuring points of the speed information and the speeds at that points are identified by interpolating points between the positions on the road using the speed information, and then the congested conditions of the road is decided.

In this case, if the position measuring points are provided densely, the identification of the road can be facilitated on the beacon side and the speed can be calculated from the position data. But the position data have such a drawback that an information content of the position data is heavier than the speed data. The position information needs almost 32 bit to represent the locus position even when the position display is represented in unit of 3 m (the resolution is 3 m), for example. In contrast, the speed information can be represented by 8 bit since normally the speed does not exceed 256 Km/h in the case of the vehicle, so that the information content is relatively light.

Therefore, if the number of the position information is suppressed to such an extent that sufficient position identifying precision (a rate of the right answer of the road by the map matching) can be obtained and then points between the position information are interpolated by a large number of speed information, an amount of data of the traveling locus data sent from the FCD in-vehicle unit can be suppressed smaller than the case where the traveling conditions are represented only the position information, and the detailed information indicating the traveling conditions can be derived on the beacon side.

The measurement of the FCD in-vehicle unit 50 is executed in principle every time when a predetermined time has lapsed (constant period system) or every distance through which the vehicle has traveled (constant distance interval system).

In the case of the constant period system, the position information are measured in a long period (e.g., 15 second to 60 second interval) and the speed information are measured in a short period (e.g., 2 second to 5 second interval). In the case of the constant distance interval system, the position information are measured every long distance (e.g., 200 m) through which the vehicle travels and the speed information are measured every short distance (e.g., 20 m) through which the vehicle travels.

The position information at each measuring point are represented by a distance L from its neighboring measuring point and an argument θ. In order to reduce an amount of data, the distance L is represented by a difference component ΔL from the distance data at its neighboring position measuring point, and the argument θ is represented by a difference component θ from the argument at its neighboring position measuring point (or θ as it is). In the case of the constant distance interval system, ΔL=0 is obtained since the distance L is constant, and thus the position can be represented only by the argument difference component Δθ (or the argument θ). The speed information V is represented by a speed difference component ΔV from the speed at its neighboring speed measuring point. These data make it possible to attain the further reduction in an amount of data by applying the variable-length coding or the run length compression.

In this manner, if the position information are represented by the distance L from its neighboring position measuring point and the argument θ, the absolute position information at the final point or the starting point are required to convert these position information into the absolute position information. However, when the information in the FCD in-vehicle unit is collected by using the beacon, the position of the beacon has already been known and thus there is no necessity to upload the absolute position information from the FCD in-vehicle unit to the beacon. As a result, an amount of data of 32 bit×2+9 to 8 bit can be reduced even by this amount.

FIG. 6 shows the measured data at the position measuring point (double circle) and the speed measuring points (white dot+double circle) in the case of the constant period system. In the case of the constant distance interval system, ΔL in the position measuring data can be omitted.

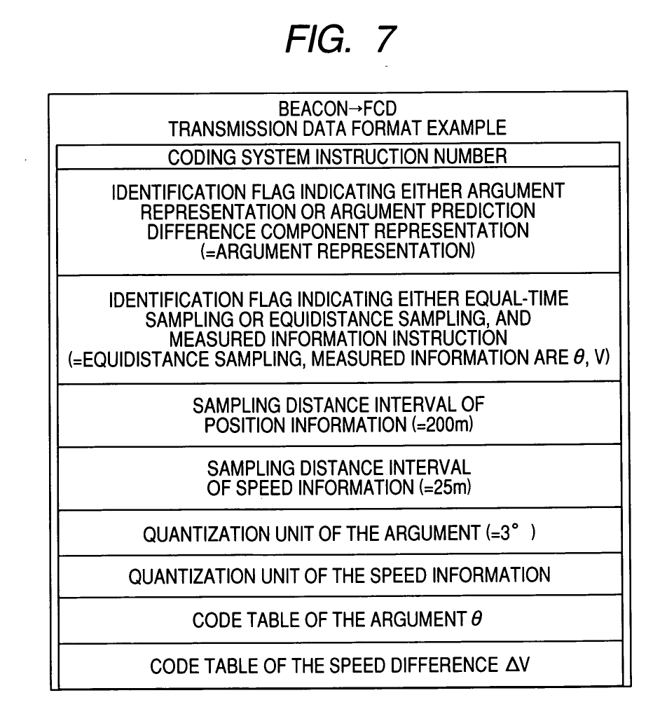

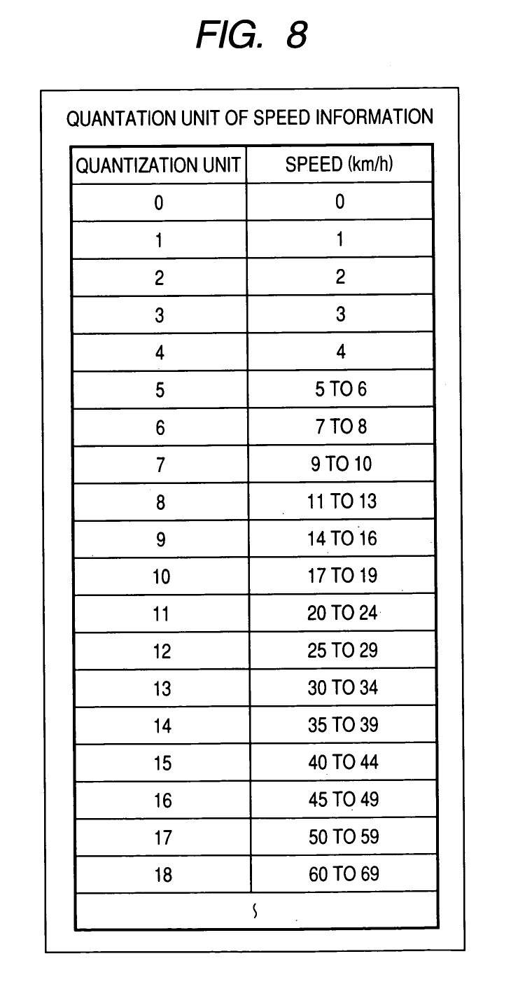

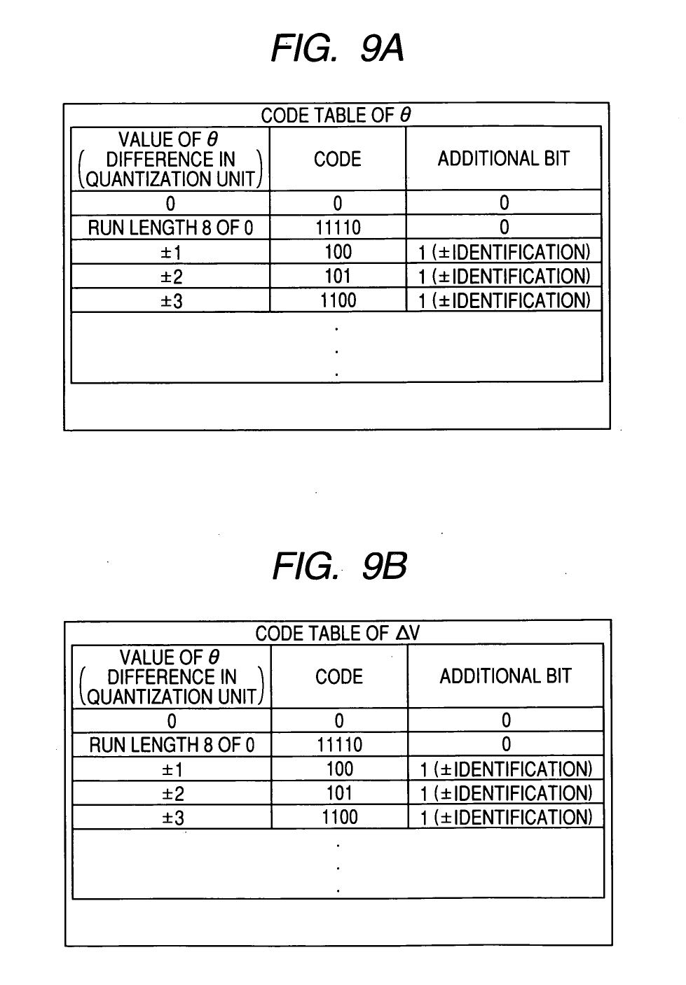

FIG. 7 shows an example of the coding instruction data that is downloaded from the upstream-side beacon 10 to the FCD in-vehicle unit. Here, there are shown an instruction number used to identify the coding system, a flag indicating whether the argument is represented as it is or the argument is represented by an argument difference component (here the argument representation is instructed), a flag indicating either the constant period system or the constant distance interval system and further indicating the measured information (here the constant distance interval system is instructed and θ, V are instructed as the measured information), a sampling distance interval pointing the measuring point interval of the position information (=200 m), a sampling distance interval pointing the measuring point interval of the speed information (=25 m), a quantization unit of the argument (=3°), a quantization unit table of the speed information shown in FIG. 8, a instruction code table of the argument θ shown in FIG. 9(a), and a code table of the speed difference component ΔV shown in FIG. 9(b).

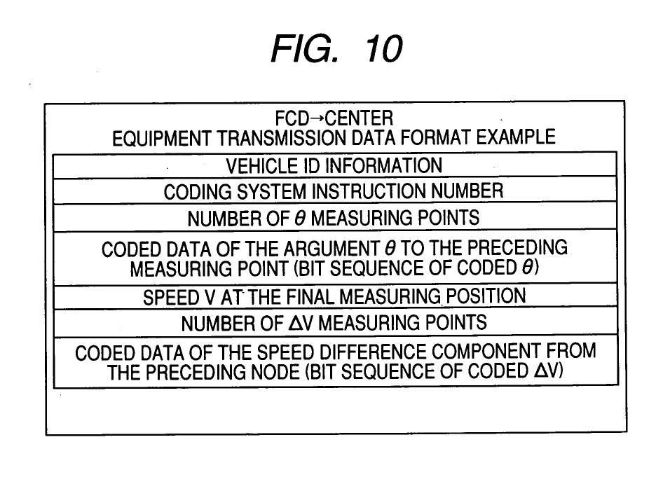

FIG. 10 shows the data that are uploaded from the FCD in-vehicle unit to the downstream-side beacon 20. Here there are shown the ID information of the vehicle into which the FCD in-vehicle unit is installed, the instruction number of the coding system contained in the coding instruction data, the number of θ measuring points, the coded data of the argument θ, the speed V at the final measuring position, the number of ΔV measuring points, and the coded data of the speed difference component.

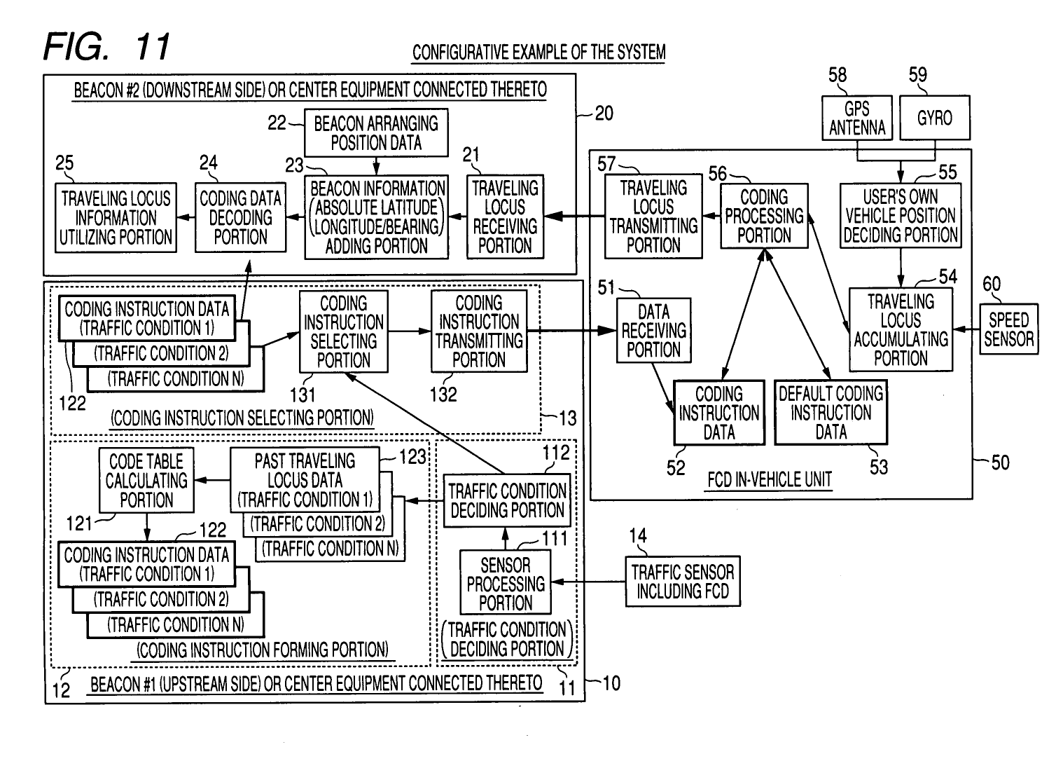

FIG. 11 shows a configuration of this system in a block diagram. A configuration of the upstream-side beacon (or the center equipment connected thereto) 10 is substantially identical to the third embodiment (FIG. 5).

The FCD in-vehicle unit 50 includes a data receiving portion 51 for receiving coding instruction data 52 from the upstream-side beacon 10, a default coding instruction data 53 held in advance by the FCD in-vehicle unit 50, a user's own vehicle position deciding portion 55 for measuring a user's own vehicle position by using a GPS antenna 58 and a gyro 59, a traveling locus accumulating portion 54 for accumulating the measured data of the user's own vehicle position and sensed data from the speed sensor 60, a coding processing portion 56 for coding the measured data accumulated in the traveling locus accumulating portion 54 by using the coding instruction data 52 or 53, and a traveling locus transmitting portion 57 for transmitting the traveling locus data to the downstream-side beacon 20.

The downstream-side beacon (or the center equipment connected thereto) 20 includes a traveling locus receiving portion 21 for receiving the traveling locus data from the FCD in-vehicle unit 50, a beacon arranging position data 22 for representing the arranging positions of the upstream-side beacon 10 and the downstream-side beacon 20, a beacon information adding portion 23 for adding the beacon position information to the traveling locus data, a coding data decoding portion 24 for decoding the coded traveling locus data, and a traveling locus information utilizing portion 25 for utilizing the decoded traveling locus data in the analysis of the traffic flow, etc.

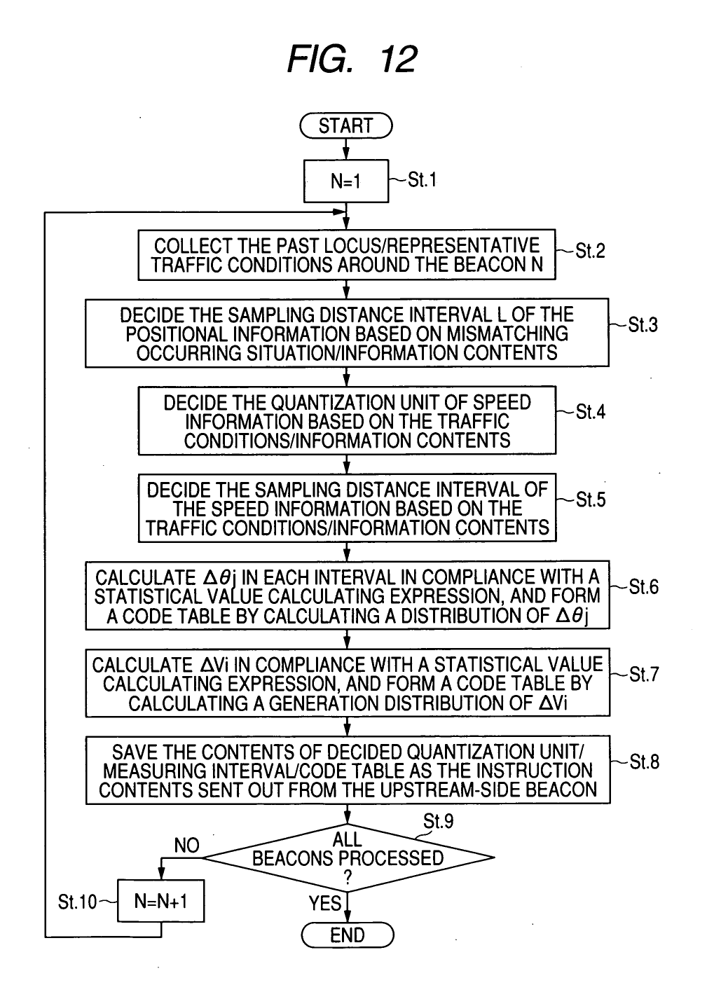

FIG. 12 shows processing procedures of the coding instruction forming portion 12 in the center equipment (FCD collecting facility) 10 to which the upstream-side beacon 10 is connected.

First, the beacon N in N=1 is selected as an object (Step 1), then the past locus and the representative traffic conditions around the beacon N are collected (Step 2), and then the sampling distance interval L of the position information is decided based on the mismatching occurring situation and the information content (Step 3). Then, the quantization unit of the speed information is decided based on the traffic conditions and the information content (Step 4), and then the sampling distance interval of the speed information is decided based on the traffic conditions and the information content (Step 5). Then, Δθj in each interval is calculated in compliance with a statistical value calculating expression, and a code table is formed by calculating a distribution of Δθj (Step 6). A Vi is calculated in compliance with a statistical value calculating expression, and a code table is formed by calculating a distribution of ΔVi (Step 7). Then, contents of the quantization unit, the measuring interval, and the code table being decided are saved as the instruction contents that are sent out from the upstream-side beacon number (Step 8). These processes are applied to all beacons (Steps 9, 10).

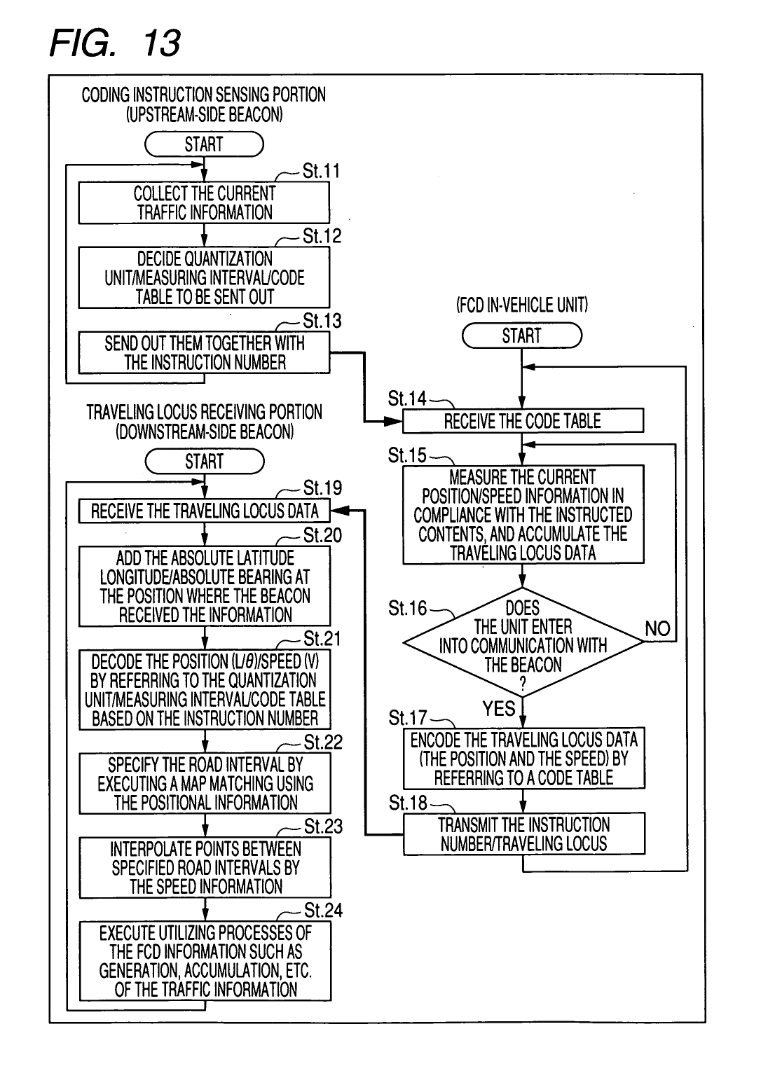

FIG. 13 shows operational procedures of the upstream-side beacon (or the center equipment connected thereto) 10, the downstream-side beacon (or the center equipment connected thereto) 20, and the FCD in-vehicle unit 50. First, the upstream-side beacon 10 collects the current traffic information (Step 11), then decides the quantization unit, the measuring interval, and the code table to be sent out (Step 12), and then sends out them together with the coding instruction number to the FCD in-vehicle unit 50 (Step 13).

Then, the FCD in-vehicle unit 50 receives the code table (Step 14), and then measures the current position and the speed information in compliance with the instructed contents and accumulates the traveling locus data (Step 15). When the FCD in-vehicle unit starts the communication with the downstream-side beacon 20 (Step 16), such unit encodes the traveling locus data (the position and the speed) by referring to the code table (Step 17) and then transmits the coding instruction number the traveling locus data to the downstream-side beacon 20 (Step 18).

Then, when the downstream-side beacon 20 receives the traveling locus data (Step 19), such beacon adds the absolute latitude longitude and the absolute bearing at the position where the beacon received the information to the traveling locus data (Step 20), and then decodes the position (L/θ) and the speed (V) by referring to the quantization unit, the measuring interval, and the code table based on the coding instruction number (Step 21).

Then, the downstream-side beacon specifies the road interval by executing the map matching using the position information (Step 22), then interpolates points between the specified road intervals by using the speed information (Step 23), and then executes utilizing processes of the FCD information such as generation, accumulation, etc. of the traffic information (Step 24).

In this fashion, in this system, the road through which the vehicle into which the FCD in-vehicle unit is installed has passed can be identified, and then the data measured by the FCD in-vehicle unit on this road can be used to analyze the traffic conditions.

In this case, the method of forming previously a plurality of patterns of the coding instruction contents by the center equipment connected to the upstream-side beacon is described. But the coding instruction contents may be calculated from the preceding information in real time if the center equipment has a sufficient CPU power.

### Fifth Embodiment

In a fifth embodiment, a system in which the FCD in-vehicle unit holds previously a plurality of code tables therein and selects automatically the code table in response to the traveling conditions will be explained hereunder.

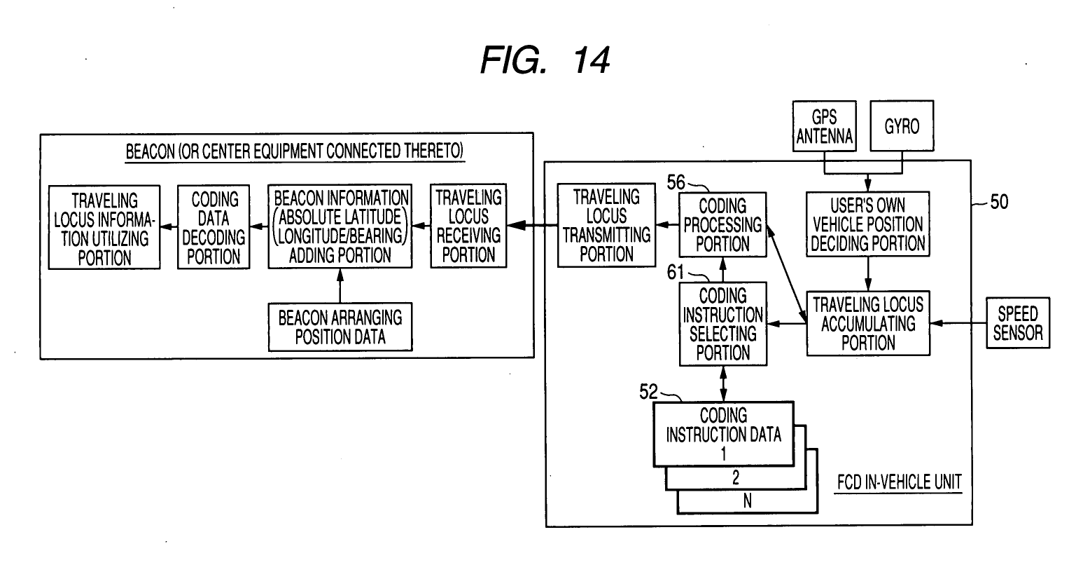

As shown in FIG. 14, the FCD in-vehicle unit includes plural coding instruction data 52 in which the sampling interval, the quantization unit, and the code table are described, and a coding instruction selecting portion 61 for selecting the to-be-used coding instruction data 52 from these coding instruction data 52.

The coding instruction selecting portion 61 selects the most suitable coding instruction data 52 from the past traveling patterns (process A).

For example, the coding instruction selecting portion accumulates the absolute value of the argument θ (or θ±90°) per unit distance (100 m) during when the vehicle travels in a predetermined distance (several km), and then decides a rank based on the accumulated value. This rank is set high in the urban district that contains many intersections, etc., and is set low in the mountainous district. The coding instruction selecting portion accumulates the absolute value of the speed difference ΔV per unit time during this traveling, and then decides another rank based on the accumulated value. This rank is set high in the urban district where the traffic congestion often occurs, and is set low in the mountainous district. Then, the coding instruction selecting portion decides the to-be-selected coding instruction data 52 on the basis of the combination of two ranks. As a result, the code table that is fitted to the traveling district can be selected.

At this time the coding instruction selecting portion 61 may decide the coding instruction data 52 while taking account of the past up-link frequencies (the coding instruction data 52 indicating the dense measurment is selected if the up-link frequency is high).

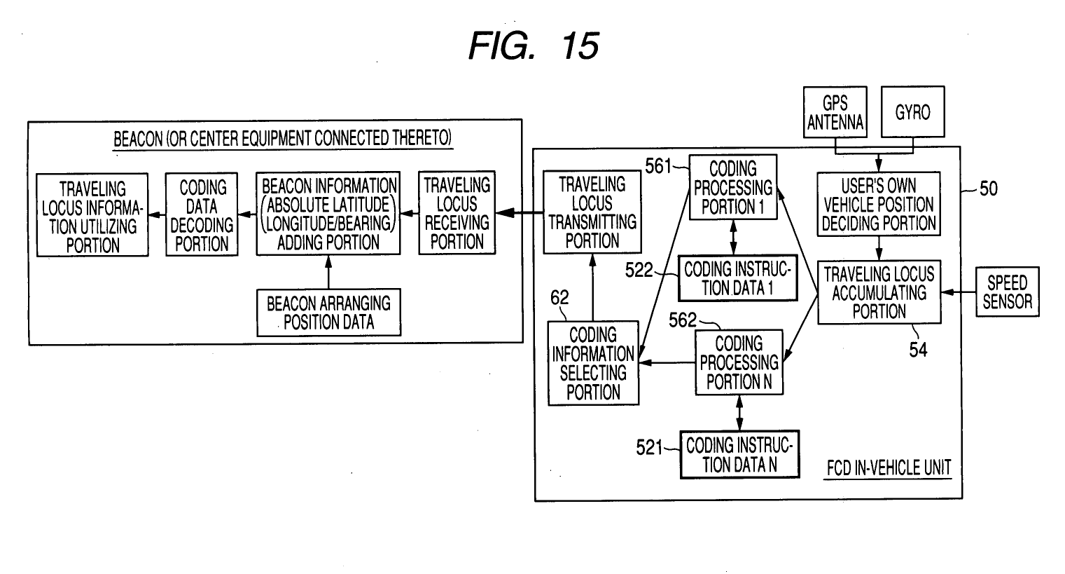

The FCD in-vehicle unit 50 shown in FIG. 15 includes a plurality of coding processing portions 561, 562 for executing the coding process in parallel based on different coding instruction data 521, 522, and a coding information selecting portion 62 for selecting the to-be-transmitted coded data from the data that are coded by the coding processing portions 561, 562.

When the coding processing portions 561, 562 hold N pieces of the coding instruction data 521, 522, such coding processing portions encode the data accumulated in the traveling locus accumulating portion 54 based on respective coding instruction data 521, 522 and generate N pieces of the coded data.

The coding information selecting portion 62 selects the most effective coded data, which attains a good balance between the information contents and the data size, from these N pieces of the coded data. The coding information selecting portion 62 decides by the following method, for example, whether or not the selected coded data are the effective coded information (process B).

Since the buffer is cleared at a time when the preceding traveling locus data are transmitted, either “the traveling locus data has already reached the buffer capacity (=the communication capacity)” for a while from the preceding transmission to this time or “the traveling locus data has not yet reached the buffer capacity” is decided when the traveling locus data are transmitted at this time.

If “the traveling locus data has already reached the buffer capacity”, it is desired to send the traveling locus information over as long the distance as possible and therefore the coded locus information capable of expressing the longest distance within a specified amount of data are transmitted. If “the traveling locus data has not yet reached the buffer capacity”, the availably detailed information are to be sent out and therefore the coded locus information having the shortest sampling interval within a specified amount of data are transmitted.

According to such algorithm, the FCD in-vehicle unit can transmit effectively the traveling locus data that are coded by using the optimum code table.

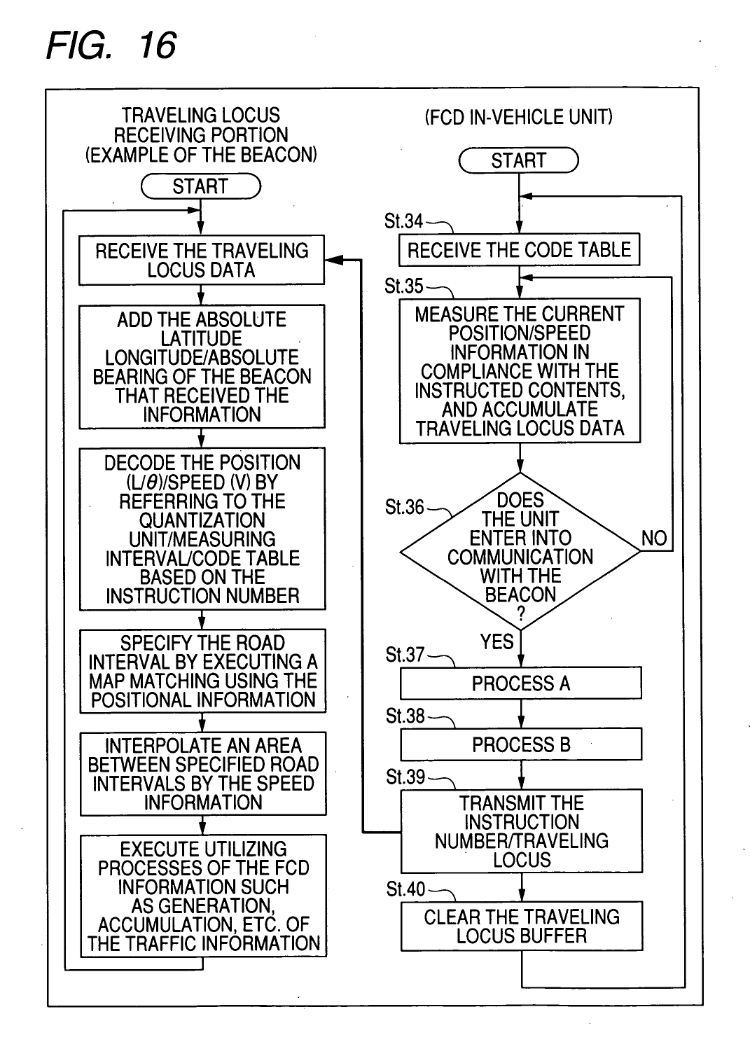

FIG. 16 shows processing procedures of the FCD in-vehicle unit 50 in this case.

First, the FCD in-vehicle unit 50 holds plural received code tables (Step 34), and then measures the current position and the speed information in compliance with the instructed contents and accumulates the traveling locus data (Step 35). When the FCD in-vehicle unit starts the communication with the downstream-side beacon 20 (Step 36), such unit executes the above process A to select the optimum coded instruction data (Step 37). Otherwise, the FCD in-vehicle unit executes the above process B to select the effective coded data from the data coded based on each coded instruction data (Step 38).

Then, the FCD in-vehicle unit transmits the coded instruction number and the coded traveling locus data to the downstream-side beacon 20 (Step 39), and then clears the traveling locus buffer (Step 40).

In this manner, in this system, the FCD in-vehicle unit can select automatically the code table in response to the traveling conditions.

The coded instruction data that the upstream-side beacon transmits to the FCD in-vehicle unit may instruct the FCD in-vehicle unit to upload the information about the stopped number and the stopped time or the information about winker/hazard/warning of incomplete door close/parking brake, and so on. These information are referred to exclude the inferior information, which act as the noise in deciding the traffic conditions, from the collected traveling locus data.

The present invention is explained in detail with reference to the particular embodiments. But it is apparent for the skilled person in the art that various variations and modifications may be applied without departing from a spirit and a scope of the present invention.

This application was filed based on Japanese Patent Application (Patent Application No. 2002-174424) filed on Jun. 14, 2002, and the contents thereof are incorporated herein by the reference.

### INDUSTRIAL APPLICABILITY

As apparent from the above explanation, according to the FCD system and facilities of the present invention, the high-precision traffic information can be obtained by collecting the traveling locus data of the vehicle effectively by using the beacons.

An amount of data that are transmitted from the in-vehicle unit to the beacon can be reduced by utilizing the fact that the positions at which the traveling locus data are collected coincide with the positions to which the fixed beacons are provided.

1-34. (canceled)

35. An FCD system for collecting traveling locus data from a in-vehicle unit in a vehicle via beacons,
wherein a downstream-side beacon collects the traveling locus data, a traveling distance of the vehicle from an upstream-side beacon to the downstream-side beacon is calculated based on the traveling locus data, and a determination is made whether or not the traveling locus data of the vehicle are used in analyzing traffic conditions of the objective road, by comparing the traveling distance with a distance on an objective road from the upstream-side beacon to the downstream-side beacon.

36. An FCD system according to claim 35, wherein the in-vehicle unit contains data of a transit time in each unit interval, which is measured in unit of a predetermined distance, in the traveling locus data.

37. An FCD system according to claim 36, wherein the deciding means decides whether or not the traveling locus data in the unit interval are used in analyzing the traffic conditions of the objective road, s based on the transit time in the unit interval.

38. An FCD system according to claim 36, wherein the in-vehicle unit represents the measured data by a difference component from data measured at a preceding measuring point.

39. An. FCD system according to claim 38, wherein the in-vehicle unit converts the data represented by the difference component into variable-length codes.

40. An FCD system according to claim 39, wherein the upstream-side beacon instructs the coding system of the data to the in-vehicle unit.

41. An FCD system according to claim 35, wherein the in-vehicle unit contains data of an average speed in each unit interval, which is measured in unit of a predetermined distance, in the traveling locus data.

42. An FCD system according to claim 41, wherein the deciding means decides whether or not the traveling locus data in the unit interval are used in analyzing the traffic conditions of the objective road, based on the average speed in the unit interval.

43. An FCD system according to claim 35, wherein the in-vehicle unit contains data of a speed, which is measured every time when the vehicle travels each unit interval in unit of a predetermined distance, in the traveling locus data.

44. An FCD system according to claim 43, wherein the deciding means decides whether or not the traveling locus data in the unit interval are used in analyzing the traffic conditions of the objective road, based on the average speed in the unit interval.

45. An FCD system according to claim 35, wherein the in-vehicle unit contains data of a traveling distance in each unit time, which is measured in unit of a predetermined time, in the traveling locus data.

46. An FCD system according to claim 45, wherein the deciding means decides whether or not the traveling locus data in the unit interval are used in analyzing the traffic conditions of the objective road, based on the average speed in the unit interval.

47. An FCD system according to claim 35, wherein the in-vehicle unit contains data of an average speed in each unit time, which is measured in unit of a predetermined time, in the traveling locus data.

48. An FCD system according to claim 47, wherein the deciding means decides whether or not the traveling locus data in the unit interval are used in analyzing the traffic conditions of the objective road, based on the average speed in the unit interval.

49. An FCD system comprising:
a plurality of beacons provided at an objective road section over which traveling locus data of a vehicle are collected from a in-vehicle unit in the vehicle;
traveling distance calculating means for calculating a traveling distance of the vehicle from an upstream-side beacon to a next downstream-side beacon on the objective road based on the traveling locus data; and
deciding means for deciding whether or not the traveling locus data of the vehicle are used in analyzing traffic conditions of the objective road section, in response to a compared result between the traveling distance and a distance on the objective road from the upstream-side beacon to the downstream-side beacon.

50. An FCD system according to claim 49, wherein the in-vehicle unit contains data of a transit time in each unit interval, which is measured in unit of a predetermined distance, in the traveling locus data.

51. An FCD system according to claim 50, wherein the deciding means decides whether or not the traveling locus data in the unit interval are used in analyzing the traffic conditions of the objective road, based on the transit time in the unit interval.

52. An FCD system according to claim 50, wherein the in-vehicle unit represents the measured data by a difference component from data measured at a preceding measuring point.

53. An FCD system according to claim 52, wherein the in-vehicle unit converts the data represented by the difference component into variable-length codes.

54. An FCD system according to claim 53, wherein the upstream-side beacon instructs the coding system of the data to the in-vehicle unit.

55. An FCD system according to claim 49, wherein the in-vehicle unit contains data of an average speed in each unit interval, which is measured in unit of a predetermined distance, in the traveling locus data.

56. An FCD system according to claim 55, wherein the deciding means decides whether or not the traveling locus data in the unit interval are used in analyzing the traffic conditions of the objective road, based on the average speed in the unit interval.

57. An FCD system according to claim 49, wherein the in-vehicle unit contains data of a speed, which is measured every time when the vehicle travels each unit interval in unit of a predetermined distance, in the traveling locus data.

58. An FCD system according to claim 57, wherein the deciding means decides whether or not the traveling locus data in the unit interval are used in analyzing the traffic conditions of the objective road, based on the average speed in the unit interval.

59. An FCD system according to claim 49, wherein the in-vehicle unit contains data of a traveling distance in each unit time, which is measured in unit of a predetermined time, in the traveling locus data.

60. An FCD system according to claim 59, wherein the deciding means decides whether or not the traveling locus data in the unit interval are used in analyzing the traffic conditions of the objective road, based on the average speed in the unit interval.

61. An FCD system according to claim 49, wherein the in-vehicle unit contains data of an average speed in each unit time, which is measured in unit of a predetermined time, in the traveling locus data.

62. An FCD system according to claim 61, wherein the deciding means decides whether or not the traveling locus data in the unit interval are used in analyzing the traffic conditions of the objective road, based on the average speed in the unit interval.

63. An FCD system comprising:
a plurality of beacons provided at an objective road over which traveling locus data of a vehicle are collected from a in-vehicle unit in the vehicle; and
deciding means for deciding whether or not the traveling locus data of the vehicle are used in analyzing traffic conditions of the objective road section, in response to a compared result between the traveling distance of the vehicle from an upstream-side beacon to a next downstream-side beacon on the objective road, which is indicated by the traveling distance data, and a distance on the objective road from the upstream-side beacon to the downstream-side beacon.

64. An FCD system according to claim 63, wherein the in-vehicle unit contains data of a transit time in each unit interval, which is measured in unit of a predetermined distance, in the traveling locus data.

65. An FCD system according to claim 64, wherein the deciding means decides whether or not the traveling locus data in the unit interval are used in analyzing the traffic conditions of the objective road, based on the transit time in the unit interval.

66. An FCD system according to claim 64, wherein the in-vehicle unit represents the measured data by a difference component from data measured at a preceding measuring point.

67. An FCD system according to claim 66, wherein the in-vehicle unit converts the data represented by the difference component into variable-length codes.

68. An FCD system according to claim 67, wherein the upstream-side beacon instructs the coding system of the data to the in-vehicle unit.

69. An FCD system according to claim 63, wherein the in-vehicle unit contains data of an average speed in each unit interval, which is measured in unit of a predetermined distance, in the traveling locus data.

70. An FCD system according to claim 69, wherein the deciding means decides whether or not the traveling locus data in the unit interval are used in analyzing the traffic conditions of the objective road, based on the average speed in the unit interval.

71. An FCD system according to claim 63, wherein the in-vehicle unit contains data of a speed, which is measured every time when the vehicle travels each unit interval in unit of a predetermined distance, in the traveling locus data.

72. An FCD system according to claim 71, wherein the deciding means decides whether or not the traveling locus data in the unit interval are used in analyzing the traffic conditions of the objective road, based on the average speed in the unit interval.

73. An FCD system according to claim 63, wherein the in-vehicle unit contains data of a traveling distance in each unit time, which is measured in unit of a predetermined time, in the traveling locus data.

74. An FCD system according to claim 73, wherein the deciding means decides whether or not the traveling locus data in the unit interval are used in analyzing the traffic conditions of the objective road, based on the average speed in the unit interval.

75. An FCD system according to claim 63, wherein the in-vehicle unit contains data of an average speed in each unit time, which is measured in unit of a predetermined time, in the traveling locus data.

76. An FCD system according to claim 75, wherein the deciding means decides whether or not the traveling locus data in the unit interval are used in analyzing the traffic conditions of the objective road, based on the average speed in the unit interval.

77. An FCD system for collecting traveling locus data from a in-vehicle unit in a vehicle via a beacon,
wherein the beacon collects the traveling locus data, transit road intervals of the vehicle, which come up to the beacon, is specified by using position data contained in the traveling locus data, and a speed is specified by interpolating points between speed data measuring points in the transit road intervals by using speed data contained in the traveling locus data.

78. An FCD system according to claim 77, wherein the in-vehicle unit measures intermittently the position data and measures the speed data at a frequency that is higher than a frequency measuring the position data.

79. An FCD system according to claim 78, wherein the in-vehicle unit measures the position data at a predetermined distance interval and also measures the speed data at another predetermined distance interval that is shorter than the predetermined distance interval.

80. An FCD system according to claim 79, wherein the position data are represented by an argument.

81. An FCD system according to claim 78, wherein the in-vehicle unit measures the position data at a predetermined time interval and measures the speed data at another predetermined time interval shorter than the predetermined time interval.

82. An FCD system according to claim 77, wherein the in-vehicle unit represents the measured data by a difference component from data measured at a preceding measuring point.

83. An FCD system according to claim 82, wherein the in-vehicle unit converts the data represented by the difference component into variable-length codes.

84. An FCD system according to claim 83, wherein the upstream-side beacon instructs the coding system of the data to the in-vehicle unit.

85. An FCD system according to claim 84, wherein, the upstream-side beacon instructs a measured value sampling interval, a quantization unit, and a code table in the coding system.

86. An FCD system comprising:
a beacon provided at an objective road section, for collecting traveling locus data including position data and speed data of the vehicle;
road interval specifying means for specifying transit road intervals of the vehicle reaching the beacon, by using the position data in the traveling locus data that are collected by the beacon; and
speed specifying means for interpolating points in the specified transit road intervals by using the speed data contained in the traveling locus data that are collected by the beacon and specifying a measuring point of the speed data and a speed at the measuring point.

87. An FCD system according to claim 86, wherein the in-vehicle unit measures intermittently the position data and measures the speed data at a frequency that is higher than a frequency measuring the position data.

88. An FCD system according to claim 87, wherein the in-vehicle unit measures the position data at a predetermined distance interval and also measures the speed data at another predetermined distance interval that is shorter than the predetermined distance interval.

89. An FCD system according to claim 88, wherein the position data are represented by an argument.

90. An FCD system according to claim 87, wherein the in-vehicle unit measures the position data at a predetermined time interval and measures the speed data at another predetermined time interval shorter than the predetermined time interval.

91. An FCD system according to claim 86, wherein the in-vehicle unit represents the measured data by a difference component from data measured at a preceding measuring point.

92. An FCD system according to claim 91, wherein the in-vehicle unit converts the data represented by the difference component into variable-length codes.

93. An FCD system according to claim 92, wherein the upstream-side beacon instructs the coding system of the data to the in-vehicle unit.

94. An FCD system according to claim 93, wherein the upstream-side beacon instructs a measured value sampling interval, a quantization unit, and a code table in the coding system.

95. An FCD collecting facility for collecting traveling locus data from a in-vehicle unit in a vehicle via beacons,
wherein the traveling locus data are collected by a downstream-side beacon, a traveling distance of the vehicle from an upstream-side beacon to the downstream-side beacon is calculated based on the traveling locus data, and a determination is made whether or not the traveling locus data of the vehicle are used in analyzing traffic conditions of the objective road, by comparing the traveling distance with a distance on an objective road from the upstream-side beacon to the downstream-side beacon.

96. An FCD collecting facility according to claim 95, wherein deciding means decides whether or not the traveling locus data in the unit interval or the unit time are used in analyzing traffic conditions of the objective road, based on a magnitude of the traveling locus data in the unit interval or the unit time.

97. An FCD collecting facility according to claim 95, further comprising:
a coding instructing means for instructing a coding system of the traveling locus data to the in-vehicle unit from the upstream-side beacon; and
a decoding means for decoding the traveling locus data collected by the downstream-side beacon by a decoding system that corresponds to the coding system.

98. An FCD collecting facility provided in plural to an objective road section, comprising:
data collecting means for collecting traveling locus data provided from a in-vehicle unit in a vehicle;
traveling distance calculating means for calculating a traveling distance of the vehicle from an upstream-side FCD collecting facility to a next downstream-side FCD collecting facility on the objective road based on the traveling locus data; and
deciding means for deciding whether or not the traveling locus data of the vehicle are used in analyzing traffic conditions of the objective road section, in response to a compared result between the traveling distance and a distance on the objective road from the upstream-side FCD collecting facility to the downstream-side FCD collecting facility.

99. An FCD collecting facility according to claim 98, wherein deciding means decides whether or not the traveling locus data in the unit interval or the unit time are used in analyzing traffic conditions of the objective road, based on a magnitude of the traveling locus data in the unit interval or the unit time.

100. An FCD collecting facility according to claim 98, further comprising:
a coding instructing means for instructing a coding system of the traveling locus data to the in-vehicle unit from the upstream-side beacon; and
a decoding means for decoding the traveling locus data collected by the downstream-side beacon by a decoding system that corresponds to the coding system.

101. An FCD collecting facility provided in plural to an objective road section, comprising:
data collecting means for collecting traveling locus data provided from a in-vehicle unit in a vehicle; and
deciding means for deciding whether or not the traveling locus data of the vehicle are used in analyzing traffic conditions of the objective road section, in response to a compared result between the traveling distance of the vehicle from an upstream-side FCD collecting facility to a next downstream-side FCD collecting facility on the objective road, which is indicated by the traveling locus data, and a distance on the objective road from the upstream-side FCD collecting facility to the downstream-side FCD collecting facility.

102. An FCD collecting facility according to claim 101, wherein deciding means decides whether or not the traveling locus data in the unit interval or the unit time are used in analyzing traffic conditions of the objective road, based on a magnitude of the traveling locus data in the unit interval or the unit time.

103. An FCD collecting facility according to claim 101, further comprising:
a coding instructing means for instructing a coding system of the traveling locus data to the in-vehicle unit from the upstream-side beacon; and
a decoding means for decoding the traveling locus data collected by the downstream-side beacon by a decoding system that corresponds to the coding system.

104. An FCD collecting facility for collecting traveling locus data from a in-vehicle unit in a vehicle via beacons, comprising: wherein the traveling locus data are collected by a downstream-side beacon, then transit road intervals of the vehicle, which come up to the downstream-side beacon from an upstream-side beacon, are specified by using position data contained in the traveling locus data, and then speed data are specified by interpolating points between speed data measuring points in the transit road intervals by using speed data contained in the traveling locus data.

105. An FCD collecting facility according to claim 104, further comprising:
a coding instructing means for instructing a coding system of the traveling locus data to the in-vehicle unit from the upstream-side beacon; and
a decoding means for decoding the traveling locus data collected by the downstream-side beacon by a decoding system that corresponds to the coding system.

106. An FCD collecting facility provided in plural to an objective road section, comprising:
a data collecting means for collecting traveling locus data containing position data and speed data of the vehicle provided from a in-vehicle unit in the vehicle;
a road interval specifying means for specifying transit road intervals of the vehicle reaching the FCD collecting facility, by using the position data contained in the collected traveling locus data; and
a speed specifying means for interpolating points in the specified transit road intervals by using the speed data contained in the collected traveling locus data and then, specifying a measuring point of the speed data and a speed at the measuring point.

107. An FCD collecting facility according to claim 106, further comprising:
a coding instructing means for instructing a coding system of the traveling locus data to the in-vehicle unit from the upstream-side beacon; and
a decoding means for decoding the traveling locus data collected by the downstream-side beacon by a decoding system that corresponds to the coding system.

108. An in-vehicle unit for transmitting traveling locus data of a vehicle equipped with the unit to beacons, comprising:
a coding means for coding the traveling locus data measured after the vehicle passed under an upstream-side beacon; and
a transmitting means for transmitting the coded traveling locus data to a downstream-side beacon.

109. A in-vehicle unit according to claim 108, wherein the coding means encodes the traveling locus data by a coding system instructed by the upstream-side beacon.

110. A in-vehicle unit according to claim 108, wherein the coding means encodes the traveling locus data by using a code table that is selected from a plurality of held code tables.

111. A in-vehicle unit according to claim 108, wherein the coding means encodes the traveling locus data by using a plurality of held code tables and then selects data transmitted to the downstream-side beacon from the coded data.
